(19) United States
(12) Patent Application Publication
(10) Pub. No.: US 2013/0235297 A1
(43) Pub. Date: Sep. 12, 2013

(54) Backlight Module

(71) Applicants: Gang Yu, Shenzhen (CN); Guofu Tang, Shenzhen (CN)

(72) Inventors: Gang Yu, Shenzhen (CN); Guofu Tang, Shenzhen (CN)

(73) Assignee: SHENZHEN CHINA STAR OPTELECTRONICS TECHNOLOGY CO LTD., Shenzhen (CN)

(21) Appl. No.: 13/521,989

(22) PCT Filed: Mar. 31, 2012
(86) PCT No.: PCT/CN12/73380

§ 371 Date: Jul. 12, 2012

(30) Foreign Application Priority Data
Mar. 8, 2012 (CN) 201210059468.9

(51) Int. Cl. F21V 8/00; G02F 1/13357

(52) U.S. Cl. 349/58; 362/617; 362/611; 349/65

(57) ABSTRACT

A backlight module is provided and it includes a waveguide having an incidence surface and an exiting surface adjacent to the incidence surface, a bottom surface, the exiting surface defined with a slot. A frame defines a space to receive the waveguide, and includes a first sidewall adjacent to the incidence surface. A first extension extends from the first sidewall toward the exiting surface, and a standoff extends from the first standoff toward the exiting surface. The standoff securely wedges into the slot, and presses against onto the exiting surface. By the provision of the present invention, the leakage of light source between the frame and the waveguide can be readily avoided as even the frame is deformed, no gap or slit will be created between the frame and the waveguide.

### FIELD OF THE INVENTION

The present invention relates to a backlight module, and more particularly to a backlight module and a liquid crystal display implemented with the backlight module.

### DESCRIPTION OF PRIOR ART

The liquid crystal display is featured with its compact, slim, low-energy exhaustion, and radiation-free, it has been widely implemented in the notebook computer, mobile phone, digital camera, monitor, and screen of electronic devices. The liquid crystal does not emit light, and as a result, it has to be lit up by a so-called backlight module. A waveguide is an indispensible part for the backlight module, and which is used to guide and direct the light toward an intended direction so as to transform a light source, line or spot, into a surface light.

As shown in FIG. 1, a typical configuration of an existing backlight module is disclosed. In the existing configuration, the backlight module includes a frame 101, and a waveguide 102. The frame 101 is provided with a plurality of standoffs 1011 which stand onto the emitting surface of the waveguide 102. Accordingly, the waveguide 102 is positioned. However, as illustrated in FIG. 2, when the frame 101 is deformed, then gap or slit will be created between the standoff 1011 and the emitting surface of the waveguide 102. Then the light from the light source will leak from those gap or slit. When the liquid crystal display is lit up, a so-called bright-line effect.

Accordingly, there is a need to provide a backlight module and a liquid crystal display incorporated with the backlight module such that the leakage of the light between the standoffs 1011 and the waveguide 102 resulted from the deformation of the frame 101 can be readily resolved.

### SUMMARY OF THE INVENTION

The purpose of the present invention is to provide a backlight module and a liquid crystal module incorporated with a backlight module so as to preferably resolve a leakage of light between an exiting surface of a waveguide and a standoff of a frame resulted from deformation of the frame.

In order to resolve the problem encountered by the prior art, a backlight module is provided and it includes a waveguide having an incidence surface and an exiting surface adjacent to the incidence surface, a bottom surface, the exiting surface defined with a slot. A frame defines a space to receive the waveguide, and includes a first sidewall adjacent to the incidence surface. A first extension extends from the first sidewall toward the exiting surface, and a standoff extends from the first standoff toward the exiting surface. The standoff securely wedges into the slot, and presses against onto the exiting surface.

Wherein the slot is sized and dimensioned in a way such that the standoff wedges into the slot even when the frame deforms.

Wherein the backlight module further includes a light source arranged between the first sidewall and the incidence surface of the waveguide.

Wherein the backlight module further comprises a fixture supporting the light source.

Wherein the fixture includes a second sidewall supporting the light source, a second extension extending from the second sidewall toward the bottom surface, and a second standoff extending from the second extension toward the bottom surface which is supported by the second standoff.

Wherein backplate is provided for supporting the second extension.

In order to resolve the technological issues encountered by the prior art, a novel liquid crystal display is provided in which a backlight module as described above is included.

Wherein the slot is sized and dimensioned in a way such that the standoff wedges into the slot even when the frame deforms.

Wherein the liquid crystal display further includes a light source arranged between the first sidewall and the incidence surface of the waveguide.

Wherein the liquid crystal display further comprises a fixture supporting the light source.

Wherein the fixture includes a second sidewall supporting the light source, a second extension extending from the second sidewall toward the bottom surface, and a second standoff extending from the second extension toward the bottom surface which is supported by the second standoff.

Wherein the liquid crystal display is provided with a backplate to support the second extension.

In order to resolve the prior art problem, a backlight module is provided and it includes a waveguide and a frame. The frame includes a standoff pressing onto an exiting surface of the waveguide which includes slot receiving the standoff of the frame.

Wherein the slot is sized and dimensioned in a way such that the standoff wedges into the slot even when the frame deforms.

Wherein the liquid crystal display further includes a light source arranged between the first sidewall and the incidence surface of the waveguide.

Wherein the liquid crystal display further comprises a fixture supporting the light source.

In order to resolve the technological issues encountered by the prior art, a novel liquid crystal display is provided in which a backlight module as described above is included.

The advantages of the present invention is that with the compact and reliable engagement between the frame and the waveguide, conventional gap or slit between the frame and the waveguide can be successfully avoided, and the bright line effect is completely prevented.

### BRIEF DESCRIPTION OF DRAWINGS

FIG. 1 is an illustrational view of a prior art backlight module;

FIG. 2 is an illustration view showing a tendency of deformation of a frame of the prior art backlight module;

FIG. 3 is an illustrational view of a backlight module made in accordance with the present invention; and

FIG. 4 is an illustration view showing a deformed frame of the backlight module in accordance with the present invention.

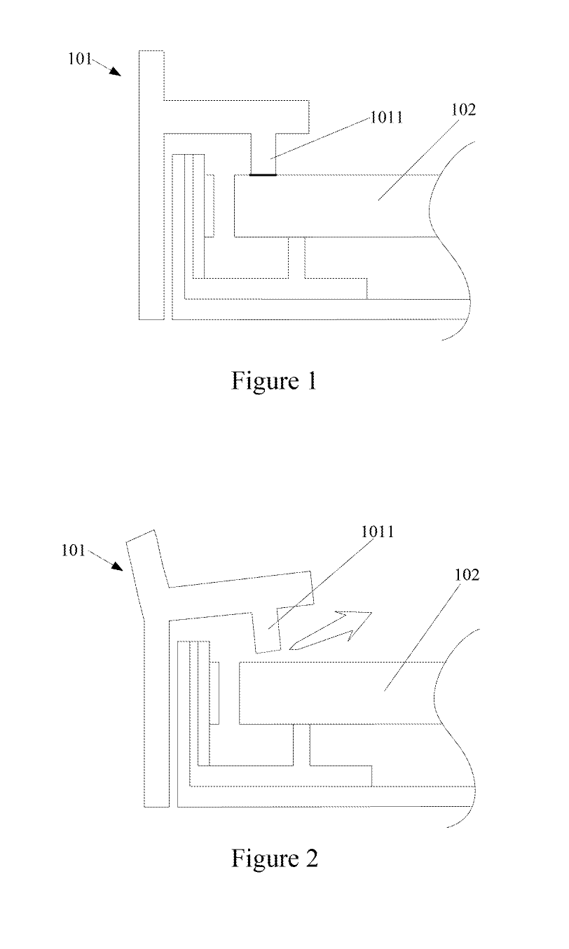

### DETAILED DESCRIPTION OF PREFERRED EMBODIMENT

Detailed description of a preferred embodiment of the present invention will be given with the accompanied drawings.

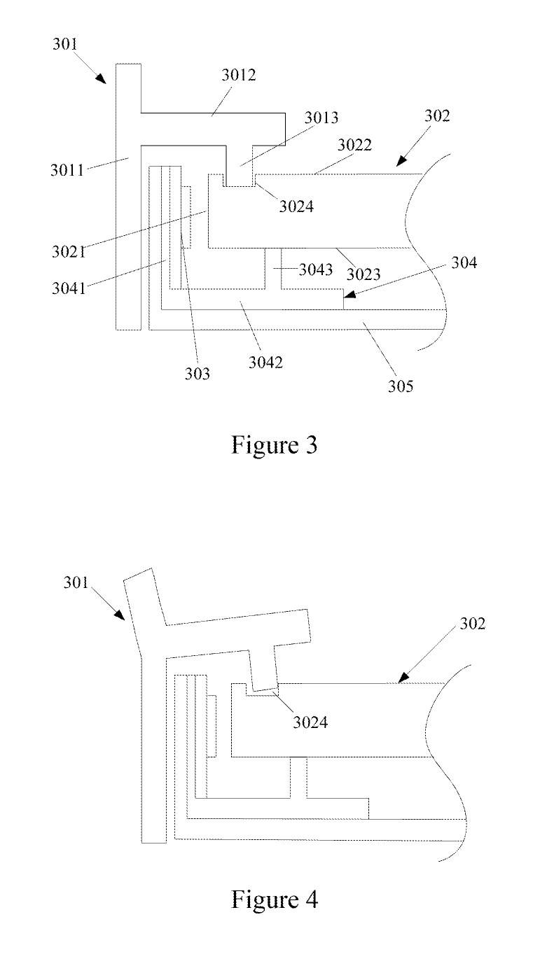

As shown in FIG. 3, an illustrational and structural view of a backlight module in accordance with the present invention is given. As shown in FIG. 3, the backlight module made in accordance with the present invention includes a frame 301, a waveguide 302, a light source 303, a light source fixture 304, and a backplate 305. The waveguide 302 includes an incidence surface 3021 and an exiting surface 3022 adjacent to the incidence surface 3021, and a bottom surface 3023. The exiting surface 3022 is provided with slots 3024. The waveguide 302 is disposed within the frame 301, and includes first sidewall 3011 adjacent to the incidence surface 3021. A first extension 3012 extends from the first sidewall 3011 to the exiting surface 3022, and a first standoff 3013 extends from the first extension 3012 to the exiting surface 3022. The standoff 3013 wedges into the slot 3024 and presses against to the exiting surface 3022.

The light source 303 is arranged between the first sidewall 3011 and the incidence surface 3021. The light source can be selected from Cold Cathode Fluorescent Lamp (CCFL), or an LED. The fixture 304 is used to support the light source 303. In this preferred embodiment, the fixture 304 includes a second sidewall 3041 used to support the light source 303, and a second extension 3042 extending from the second sidewall 3041 to the bottom surface 3023. A second standoff 3043 extends from the second extension 3042 to the bottom surface 3023, which is further supported by the second standoff 3043. The fixture 304 is made from preferable heat conductive material, such as aluminum, so as to dissipate the heat generated from the light source 303. In other preferred embodiment, the fixture 304 can be implemented with other configuration or in some case, it can be omitted.

The second extension 3042 of the fixture 304 of the backlight defines a receiving space for the waveguide 302, the light source 303, and the fixture 304 jointly with the frame 301. Reflective layer or reflective foil can be deployed over the surface adjacent to the bottom 3023 of the waveguide 302 and the backplate 305. Accordingly, the leaked light from the bottom surface 3023 can be reflected back to the waveguide 302. As a result, no energy losses, while the efficiency increases.

As shown in FIG. 4, in the present invention, the size and dimension of the slot 3024 are optimized in a way such that when the frame 301 deforms, the first standoff 3013 is still wedged within the slot 3024. Frame 301 is flexible and deformable so as to absorb any external force, and it is used to support and position the internal parts of the backlight module. As a result, when the backlight module is suffered from vibration, impact, or even drop-off, the frame 301 can be readily deformed. With the provision of the above described configuration, even when the frame 301 is deformed, the standoff 3013 still securely wedges into the slot 3024 of the waveguide 302. Accordingly, no gap or slit will be generated between the frame 301 and the waveguide 302 even when the frame 301 is deformed. Therefore, the bright line effect encountered by the prior art is successfully avoided.

Of course, with the revelation of the above description, any skilled in the art can embody additional and many implementations between the frame and the waveguide. For example, providing some sort of slots on the exiting surface of the waveguide, and have the frame press onto the exiting surface, and have the standoff wedges into the slot, then the purpose of the present invention is achieved. Again, the size and dimension of the slot can be embodied in a way such that the standoff wedges into the slot firmly even when the frame is deformed.

By the provision of the backlight module in accordance with the present invention, then a liquid crystal display can be readily embodied with this novel backlight module.

By the provision of the present invention, the leakage of light source between the frame and the waveguide can be readily avoided as even the frame is deformed, no gap or slit will be created between the frame and the waveguide.

The above described is merely preferred embodiment of the present invention, and it is merely for illustration while not for limitation. As a result, any alternation and modification or any equivalents based on the specification as well as the drawings will be covered by the attached claims even they are applied to other fields of technology directly or indirectly.

1. A backlight module, comprising
a waveguide having an incidence surface and an exiting surface adjacent to the incidence surface, and a bottom surface, the exiting surface defined with a slot; and
a frame defining a space to receive the waveguide, and including a first sidewall adjacent to the incidence surface, a first extension extending from the first sidewall toward the exiting surface, and a standoff extending from the first standoff toward the exiting surface, the standoff wedging into the slot, and pressing against onto the exiting surface.

2. The backlight module as recited in claim 1, wherein the slot is sized and dimensioned in a way such that the standoff wedges into the slot even when the frame deforms.

3. The backlight module as recited in claim 1, wherein the backlight module further includes a light source arranged between the first sidewall and the incidence surface of the waveguide.

4. The backlight module as recited in claim 3, further comprising a fixture supporting the light source.

5. The backlight module as recited in claim 4, wherein the fixture includes a second sidewall supporting the light source, a second extension extending from the second sidewall toward the bottom surface, and a second standoff extending from the second extension toward the bottom surface which is supported by the second standoff.

6. The backlight module as recited in claim 5, wherein backplate is provided for supporting the second extension.

7. A liquid crystal display, characterized in that it comprises a backlight module recited in claim

8. The liquid crystal module as recited in claim 7, wherein the slot is sized and dimensioned in a way such that the standoff wedges into the slot even when the frame deforms.

9. The liquid crystal module as recited in claim 8, wherein the backlight module further includes a light source arranged between the first sidewall and the incidence surface of the waveguide.

10. The liquid crystal module as recited in claim 9, further comprising a fixture supporting the light source.

10. The liquid crystal module as recited in claim 10, wherein the fixture includes a second sidewall supporting the light source, a second extension extending from the second sidewall toward the bottom surface, and a second standoff extending from the second extension toward the bottom surface which is supported by the second standoff.

12. The liquid crystal module as recited in claim 11, wherein backplate is provided for supporting the second extension.

13. A backlight module, characterized in that the backlight module includes a waveguide and a frame, the frame including a standoff pressing onto an exiting surface of the waveguide which includes slot receiving the standoff of the frame.

14. The liquid crystal module as recited in claim 13, wherein the slot is sized and dimensioned in a way such that the standoff wedges into the slot even when the frame deforms.

15. The liquid crystal module as recited in claim 13, wherein the backlight module further includes a light source arranged between the first sidewall and the incidence surface of the waveguide.

16. The liquid crystal module as recited in claim 15, further comprising a fixture supporting the light source.
